(19) United States
(12) Patent Application Publication
(10) Pub. No.: US 2024/0239015 A1
(43) Pub. Date: Jul. 18, 2024

(54) RESIDUAL CONCRETE MIX COMPONENT SEPARATION SYSTEM

(71) Applicant: Artem Sergeevich KOGAN, MOSCOW (RU)

(72) Inventor: Artem Sergeevich KOGAN, MOSCOW (RU)

(21) Appl. No.: 18/561,709

(22) PCT Filed: May 12, 2022
(86) PCT No.: PCT/RU2022/050150

§ 371 Date: Nov. 16, 2023

(30) Foreign Application Priority Data
May 17, 2021 (RU) 2021113869

(51) Int. Cl. B28C 9/00; B07B 1/36; B28C 7/00

(52) U.S. Cl. CPC B28C 9/002; B28C 7/0007; B07B 1/36; B07B 2201/04

(57) ABSTRACT

A system for separating components of a residual concrete mixture comprising a frame with a rail, a lifting device suspending vibrating sieves of different mesh sizes configured to move horizontally and vertically and to change and angle of inclination, a process tank with a water under the vibrating sieves with water level control means, a pump in a bottom the process tank configured to move a water-cement mixture previously passed through the vibrating sieves, comprising a movable control nipple configured to determine a cement concentration and directing subsequently the water-cement mixture in a first tank if its density is higher to a predetermined value, or in the second tank, if the density of the mixture is below the predetermined value, through a sand filter, also serving as a sand hopper of sand sifted on a lower sieve; and a control unit configured to control the system.

### TECHNICAL FIELD

The invention relates to the field of construction and is intended for the separation of components of the residual concrete mixture.

### BACKGROUND

The reuse (recycling) of concrete mixture is an actual task in construction. In the recycling process, the residual concrete mixture is separated into fractions, which are subsequently used in construction.

A mobile residual concrete mixture recycling device according to CN203185500 (publ. Nov. 9, 2013) is known. The device comprises a feed chute for supplying water for vehicle washing, a sand and gravel separation unit, a hydrocyclone separation system, a mixing box, a conduit system, a filter pressing system and an automatic control unit. The sand and gravel separation unit comprises a concrete mixture separator and a screen for separating sand and stone; the hydrocyclone separation system comprises a hydrocyclone separator with a chute. Compared with the prior art, the mobile residual concrete mixture recycling device provides reuse of the concrete mixture, and has certain advantages, in particular: the mixer is made as the mixing box, which eliminates the need for additional cleaning of the mixer when using this device and improves the device usability; the vibration motor is mounted on a frame with a chute for unloading material from the washed vehicles, which increases the smoothness of the material feed. A disadvantage of this device is a large amount of polluted water which must be purified for subsequent use in a complex and expensive process.

A residual wet concrete recycling system disclosed in CN201960669 (publ. Jul. 9, 2011) is known, which comprises a vehicle flushing groove, a sand and gravel separation unit comprising a wet concrete recycling unit, a wet concrete feed channel connected to the vehicle flushing groove, and a drain device configured on the recycling unit; the residual wet concrete recycling system is additionally provided with a pretreatment device for pretreating the muddy water coming out of the sand and gravel separation unit. Compared to the prior art, in the residual wet concrete recycling system the muddy water is drained from the wet concrete recycling system and passed through the pretreatment device for further separation, after which the low concentrated muddy water corresponding to the concrete production requirements is released into the mixing basin, wherein the muddy water no longer contains solids and the muddy water concentration is significantly reduced, ensuring proper concrete production quality.

A disadvantage of the known solutions is a high wear of certain structural elements due to the friction of the components of the residual mixture on such elements.

### SUMMARY

The object of the invention is to develop a system for separation of the components of the residual concrete mixture, which excludes the disadvantages of the solutions known from the state of the art.

The technical result of the claimed invention is to increase the operational reliability of the system for separation of the components of residual concrete mixture.

The claimed technical result is achieved due to the fact that the system for separation of the components of the residual concrete mixture contains a frame with a rail fixed on it, on which at least one lifting device is placed, which suspends two or more vibrating sieves configured to move horizontally and vertically, as well as to change their angle of inclination, and having different mesh sizes; a process tank with a water, placed under the vibrating sieves and having upper and lower level sensors controlling the water level in the tank, wherein in a bottom part of the process tank there is a pump connected to the conduit of a water distribution system and configured to move a water-cement mixture obtained in the process tank and previously passed through the vibrating sieves, wherein the conduit comprises a movable control nipple, configured to determine a cement concentration depending on the density of the water-cement mixture and to direct subsequently the water-cement mixture in the first tank, if its density is higher or equal to a predetermined value, or in the second tank, if the density of the water-cement mixture is below the predetermined value; a control unit configured to control an operation of the system for separation of the components of the residual concrete mixture.

In addition, in the system for separation of the components of the residual concrete mixture the vibrating sieve screen can be made of polymer.

In addition, in the system for separation of the components of the residual concrete mixture the vibrating sieve screen can be made of metal with a polymer coating.

In addition, in the system for separation of the components of the residual concrete mixture, an additional sand filter is arranged upstream of the second tank and which is also a hopper for the sand sifted through the lower sieve.

### BRIEF DESCRIPTION OF THE DRAWINGS

The drawings of the application are presented in a form sufficient for the understanding of the essence of the invention by the persons skilled in the art, and in no way limit the patentable scope of the invention. In the drawings the same elements have the same reference numbers.

One should understand that the figures show only those operations that require clarification, while some operations of the proposed method are clear to the person skilled in the art and do not require additional illustrations.

FIG. 1 shows a general side view of the system;

FIG. 2 shows a general top view of the system;

FIG. 3 shows a side view of the vibrating sieve suspension system;

FIG. 4 shows an end view of the vibrating sieve suspension system;

FIG. 5-6 shows the algorithm of operation of the control nipple with counterweight

FIG. 7 shows the loading of the residual concrete mix. End view.

FIG. 8 shows the loading of the residual concrete mix. Side view.

FIG. 9 shows a variant of unloading the vibrating sieve suspension system.

### EMBODIMENTS

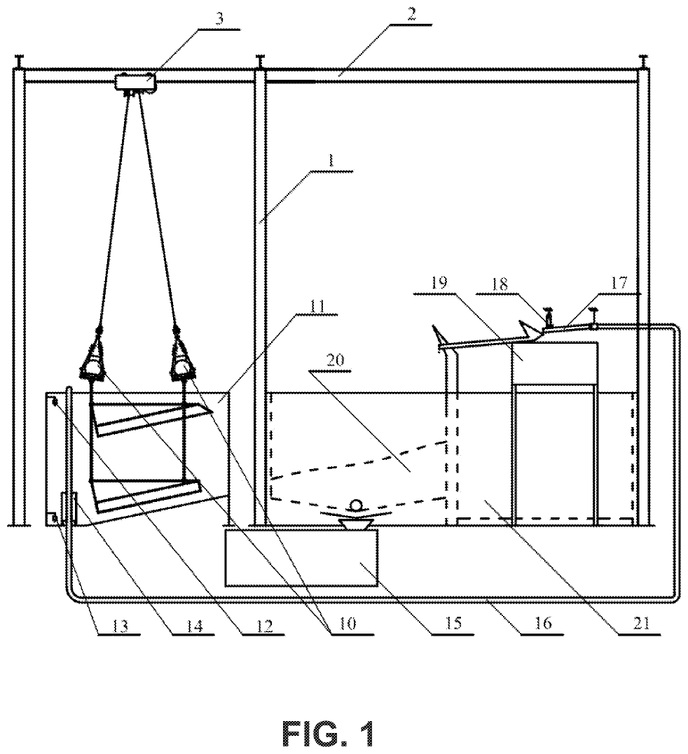

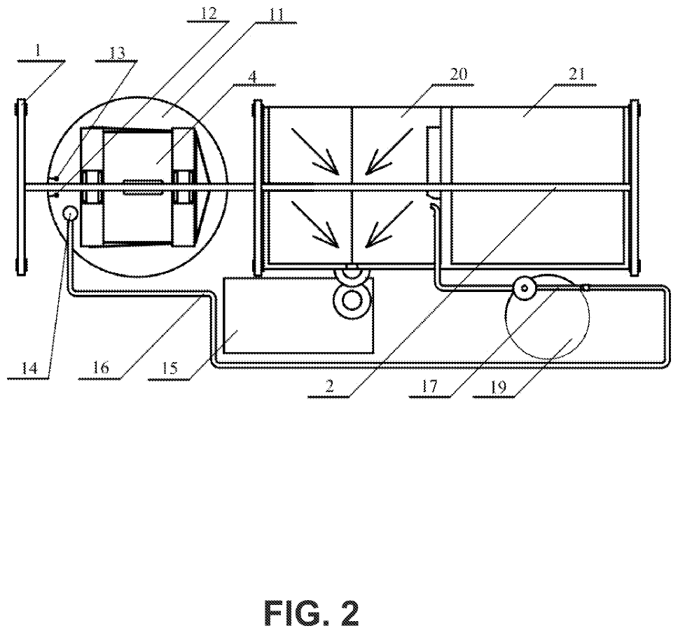

The claimed system for separation of the components of the residual concrete mixture shown in FIG. 1 and FIG. 2, comprises a frame 1, which is a structure configured to accommodate a rail 2 and main units of the system, thereby reducing the size of the system for separation of the components of the residual concrete mixture.

The rail 2 accommodates at least one lifting device 3, which in the preferred embodiment is a hoist with two cables on reels of different diameters, but is not limited with this.

The lifting device 3 serves to provide suspension, as well as movement in both horizontal and vertical directions of two or more vibrating sieves 4 and 5, which are placed under each other. It should be noted, that the lifting device 3 synchronously changes the angle of inclination of one of the sides of the vibrating sieves 4 and 5 during vertical movement.

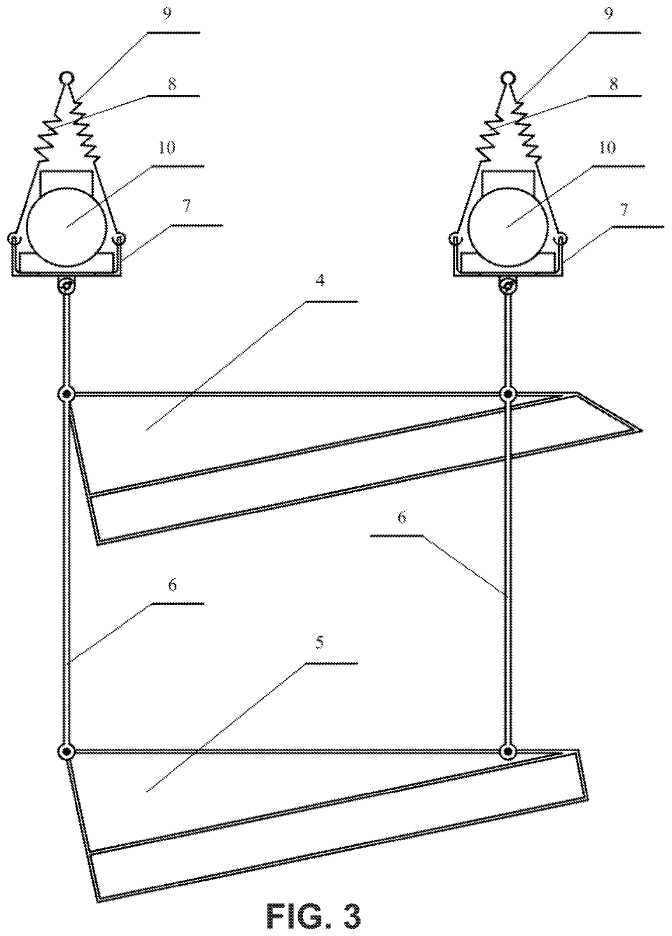

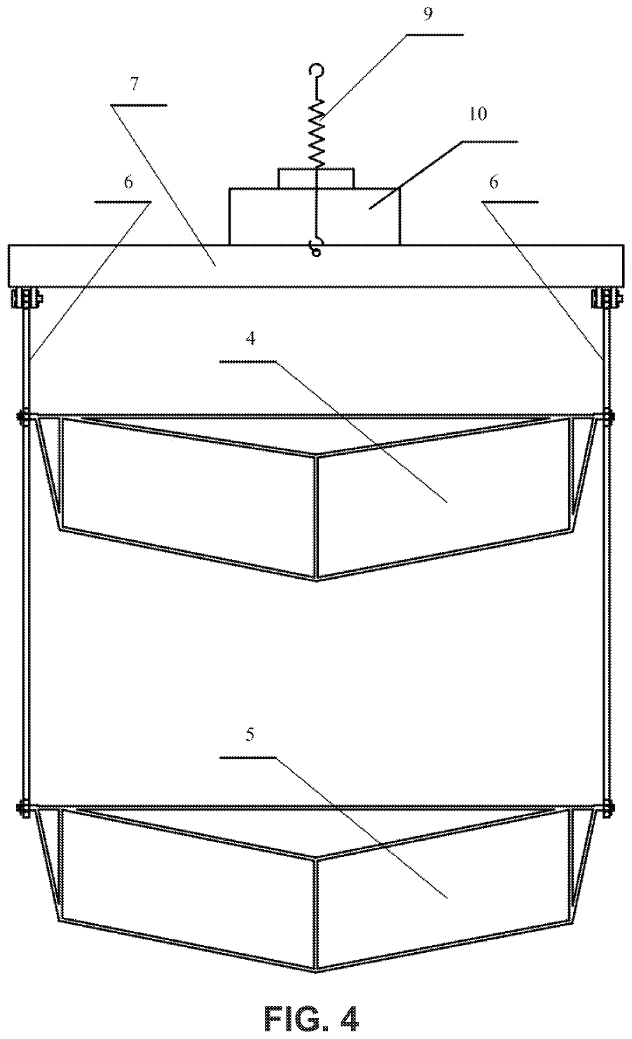

As it is shown in the FIG. 3-4, one of the possible, but not the only, variants is to suspend the vibrating sieves 4 and 5 by means of the rigid rods 6 to the cross beams 7. In their turn, the cross beams 7 through springs 8 and 9 of different stiffness are suspended on the lifting device 3. The difference in the stiffness of the springs 8 and 9 is due to the fact that such a design prevents vibration of the lifting device 3 from the vibration motors 10 mounted on the cross beams 7. The vibrating sieves 4 and 5 have different mesh sizes, wherein the vibrating sieve 4, placed above, has a larger mesh size than the vibrating sieve 5, placed below it. The difference in the mesh size is due to the fact that the mesh size is selected depending on the type of a fraction to be retained by the sieve and a fraction to be sifted through it. In other words, the mesh size of the upper vibrating sieve 4 is sufficient to retain gravel and sifting sand with cement through it, and the mesh size of the lower vibrating sieve 5 is sufficient to retain the sand and sifting cement through it. In this case, the vibration of the sieves 4 and 5 is provided by vibration motors 10 and is transmitted through the cross beams 7 and the rigid rods 6.

In addition, the screens of vibrating sieves 4 and 5 can be made of different materials and combinations thereof. So, the screens can be made of metal, polymer or a combination thereof, which makes it possible to increase the wear resistance of the vibrating sieves 4 and 5.

As it is shown in the FIG. 1, there is a process tank 11 with a water under the vibrating sieves 4 and 5, in which the vibrating sieves 4 and 5 are sunk, after which the components of the residual concrete mixture are sieved. Wherein, in the process tank 11 the upper level sensor 12 and lower level sensor 13 are placed, controlling the water level in the process tank 11.

The upper level sensor 12 controls the upper water level, which prevents the water overflow, and the lower level sensor 13 prevents the pump 14 from running dry. The water can be supplied to the process tank 11 from a water supply system or the second tank 15.

The pump 14, installed in the process tank 11 is connected to the conduit 16 of the water distribution system and configured to move a water-cement mixture obtained in the process tank 11. The water-cement mixture is obtained in the process tank 11 due to the fact that the vibrating sieves 4 and 5, on which the residual concrete mixture is unloaded, are sunk into the process tank 11 with the water and subjected to vibration. The vibrating sieves 4 and 5 pass fractions according to their mesh size, so that the cement fraction falls into the water as the finest.

After lifting the vibrating sieves 4 and 5 from the process tank 11, the water-cement mixture settles. The cement sinks to the bottom. Therefore, when the pump 14 is subsequently turned on, first a high-density water-cement mixture enters the conduit 16 due to the high concentration of the cement in it. After that, a low density water-cement mixture enters the conduit 16 due to the low concentration of cement in it.

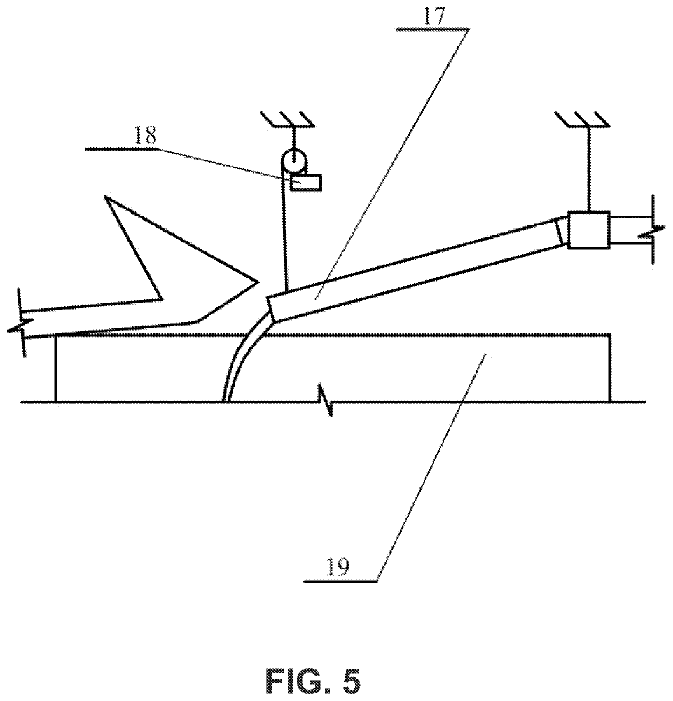

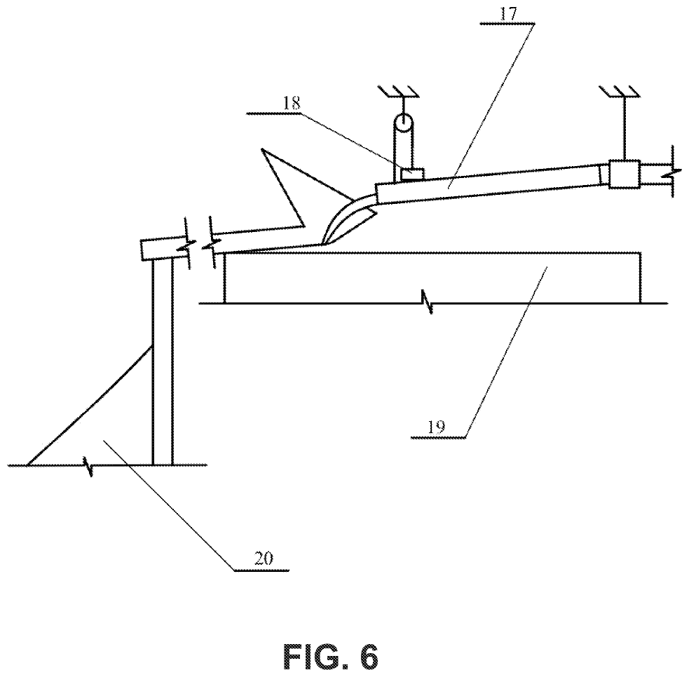

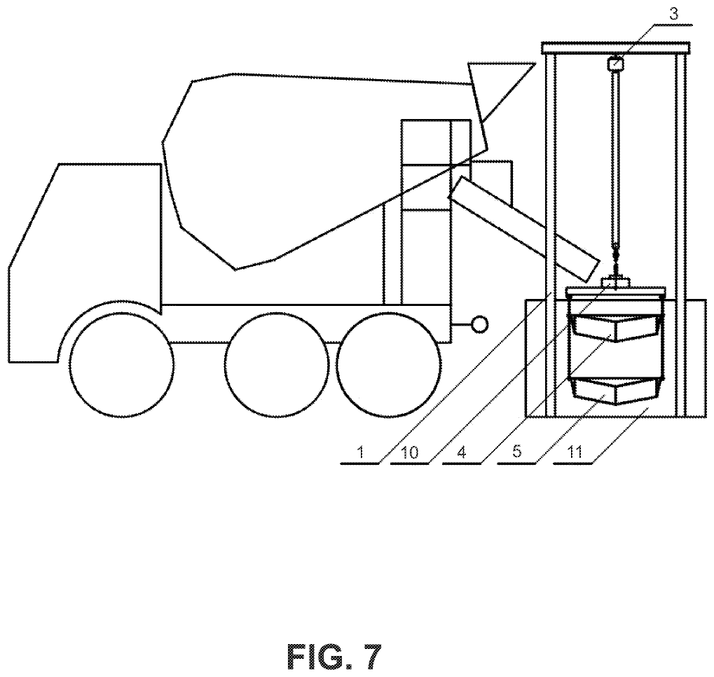

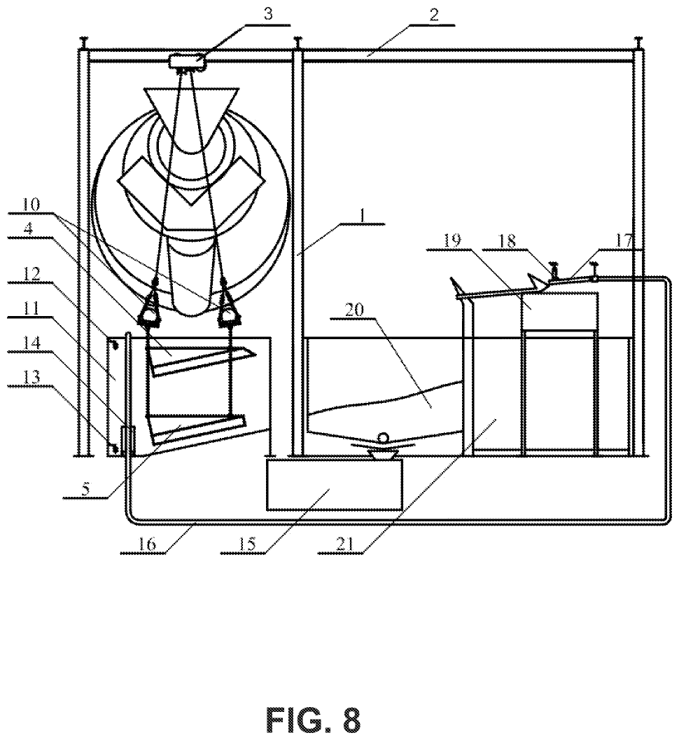

The conduit 16 is connected to a movable control nipple 17, whose mechanism in the preferred embodiment is the counterweight 18, but is not limited to this. As it is shown in the FIG. 5-6, if the density of the water-cement mixture is higher or equal to a predetermined value, the control nipple 17 directs the water-cement mixture into the first tank 19. The density of the water-cement mixture entering the first tank 19 is in the range 1.4-1.8 t/m3.

Later on, the water-cement mixture from the first tank 19 can be used to produce low quality concrete.

For a better separation of water from the cement the additional sand filter 20 is arranged upstream the second tank 15 which serves as a hopper for the sand, sifted on the lower sieve 5; through this filter the water-cement mixture with a reduced cement concentration passes.

If the density of the water-cement mixture is below the predetermined value, the nipple 17 directs the water-cement mixture into the sand filter 20, which simultaneously serves as the sand hopper sifted on the lower sieve 5. After passing through the sand filter 20, the water becomes purified. The bottom of the sand filter 20 has slopes towards the drain hole. The purified water from the sand filter 20 enters through the drain hole in the wall into the second tank 15. The drain hole in the wall of the sand filter 20 is made in such a way that allows the water to flow out, but does not allow the sand to spill out.

The process water from the second tank 15 is reused as the water in the process tank 11 for immersion of the vibrating sieves, washing mixers, etc.

The control unit controls the operation of the entire system for separation of the components of the residual concrete mixture.

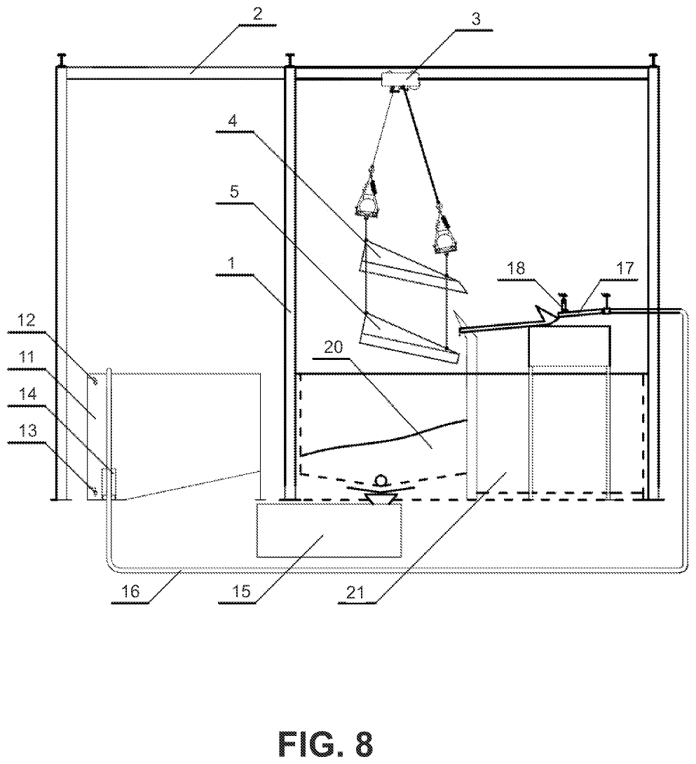

As it is shown in the FIG. 9, after sifting on the vibrating sieves 4 and 5, the control unit turns off the vibration motors 10. The gravel remains on the upper sieve 4. The sand remains on the lower sieve 5. The control unit turns on the motor of the lifting device 3. Since the cables of the lifting device 3 are wound on the reels of different diameters, which are calculated in advance, when lifting, there is a parallel change in the angle of inclination of the vibrating sieves 4 and 5. The change in the angle of inclination of the vibrating sieves 4 and 5 is in the range of 20-30 degrees. Then the lifting device 3 moves along the rail 2 in a horizontal direction.

The control unit stops moving in the horizontal direction when the upper edge of the separating wall between the sand filter 20 and the gravel hopper 21 is between the edges of the vibrating sieves 4 and 5.

After that, the control unit turns on the vibration motors 10. The gravel from the vibrating sieve 4 is discharged into the gravel hopper 21. The sand from the vibrating sieve 5 is discharged into the sand filter 20, which is also the sand hopper. After that the gravel and the sand can be used again to produce concrete.

The claimed system for separation of the components of the residual concrete mixture has some advantages over known systems, including:

a reduced size provided by the frame and vibrating sieve suspension system, which allows to place such a system in a limited space;

an increased operational reliability, which is ensured by damping of vibration from the system operation by the suspension system with the springs of different stiffness, as well as by the use of the polymer screens with increased wear resistance;

the simplified water distribution system, using the moving control nipple with counterweight instead of electrified counterparts, not only reduces the risk of breakdown due to the simplified operating principle, but also simplifies operation and maintenance;

using of the sand filter, which simultaneously serves as the sand hopper for the sand sifted on the lower sieve, allows to reduce costs for the installation and operation of filtering equipment, as the sand from the filter is constantly replenished: sifting— feeding into the sand filter, which simultaneously serves as the sand hopper— concrete production;

in addition, the claimed system for separation of the components of the residual concrete mixture provides increased environmental friendliness of operation, as it provides a closed cycle of water use, without its emissions into the environment.

1-4. (canceled)

5. A system for separating the components of a residual concrete mixture, comprising:
a frame holding a rail,
at least one lifting device held by the rail suspending at least an upper vibrating sieve and a lower vibrating sieve of different mesh sizes, configured to move the vibrating sieves horizontally and vertically and to control an inclination angle of the vibrating sieves;
a process tank containing water, placed under the vibrating sieves and comprising an upper level sensor and a lower level sensor for controlling the water level in the process tank,
wherein a pump connected to a conduit of a water distribution system is set at a bottom of the process tank and configured to move a water-cement mixture obtained in the process tank and previously passed through the vibrating sieves,
wherein the conduit of the water distribution system comprises a movable control nipple configured to direct the water-cement mixture based on a cement concentration according to a density of the water-cement mixture, either to a first tank if the density if the water-cement mixture is higher or equal to a predetermined value, or in a second tank, if the density of the water-cement mixture is below the predetermined value;
a control unit configured to control an operation of the system.

6. The system of claim 1, wherein a vibrating sieve screen is made of a polymer.

7. The system of claim 1, wherein a vibrating sieve screen is made of metal with a polymer coating.

8. The system of claim 1, wherein a sand filter is arranged upstream the second tank and serves as a hopper for sand sifted on the lower sieve.
